(19) United States
(12) Patent Application Publication
(10) Pub. No.: US 2026/0049845 A1
(43) Pub. Date: Feb. 19, 2026

(54) BATTERY SWELLING SENSOR

(71) Applicant: Cypress Semiconductor Corporation, San Jose, CA (US)

(72) Inventor: Jiawei LIANG, Shenzhen (CN)

(73) Assignee: Cypress Semiconductor Corporation, San Jose, CA (US)

(21) Appl. No.: 18/805,107

(22) Filed: Aug. 14, 2024

(51) Int. Cl. G01D 5/20; H01M 10/42; H01M 10/48

(52) U.S. Cl. CPC G01D 5/20; H01M 10/425; H01M 10/48

(57) ABSTRACT

In an embodiment of the techniques presented herein, a device has a battery with a conductive surface, an inductive sensor, a spacer between the inductive sensor and the conductive surface, and a processing unit connected to the inductive sensor and configured to apply an excitation signal to the inductive sensor, determine a battery swelling metric based on a response, in the conductive surface, to the excitation signal, and control the device based on the battery swelling metric. In an embodiment of the techniques presented herein, a method includes applying an excitation signal to an inductive sensor spaced apart from a conductive surface of a battery, determining a battery swelling metric based on a response, in the conductive surface, to the excitation signal, and controlling a device comprising the battery based on the battery swelling metric.

### BACKGROUND

Batteries are used to provide power to many items, such as mobile communication devices, computing devices, game systems, Internet of Things (IoT) devices, drones, toys, and other devices. Battery over-charging or over-discharging can cause damage.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In an embodiment of the techniques presented herein, a device comprises a battery comprising a conductive surface, an inductive sensor, a spacer between the inductive sensor and the conductive surface, and a processing unit connected to the inductive sensor and configured to apply an excitation signal to the inductive sensor, determine a battery swelling metric based on a response, in the conductive surface, to the excitation signal, and control the device based on the battery swelling metric.

In an embodiment of the techniques presented herein, a method comprises applying an excitation signal to an inductive sensor spaced apart from a conductive surface of a battery, determining a battery swelling metric based on a response, in the conductive surface, to the excitation signal, and controlling a device comprising the battery based on the battery swelling metric.

In an embodiment of the techniques presented herein, a system comprises means for applying an excitation signal to an inductive sensor spaced apart from a conductive surface of a battery, means for determining a battery swelling metric based on a response, in the conductive surface, to the excitation signal, and means for controlling a device comprising the battery based on the battery swelling metric.

In an embodiment of the techniques presented herein, a device comprises a battery comprising a conductive surface, an inductive sensor, a spacer between the inductive sensor and the conductive surface, and a processing unit connected to the inductive sensor and configured to apply an excitation signal to the inductive sensor, determine a distance between the inductive sensor and the battery based on a response, in the conductive surface, to the excitation signal, and control the device based on the distance, wherein controlling the device comprises generating an alert message responsive to the distance being less than a first threshold, and changing an operating parameter of the device responsive to the distance being less than a second threshold that is less than the first threshold.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a block diagram of a device with battery damage detection, in accordance with some embodiments.

FIGS. 2 and 3 are diagrams of the battery interfacing with the inductive sensor, in accordance with some embodiments.

FIG. 4 is a circuit diagram of an inductive sensor, in accordance with some embodiments.

FIG. 5 is a diagram illustrating inductive sensing, in accordance with some embodiments.

FIG. 6 is a diagram illustrating an excitation signal (Lx) and a receive signal (Rx) for inductive sensing, in accordance with some embodiments.

FIGS. 7A and 7B are diagrams illustrating a method for battery fault detection and/or mitigation, in accordance with some embodiments.

FIG. 8 illustrates an exemplary embodiment of a computer-readable medium, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by “about” or “approximately” the indicated value, and take into account experimental error and variations that would be expected by a person having ordinary skill in the art.

Batteries used to provide electronic devices are susceptible to damage from over-charging, over-discharging, or extended use at high load. Battery damage can cause swelling of the battery module that can in turn damage the device or cause a safety issue. Battery damage detection allows control actions to be taken prior to causing further damage to the battery or the device, such as alert messages, battery throttling, battery replacement, or some other control action.

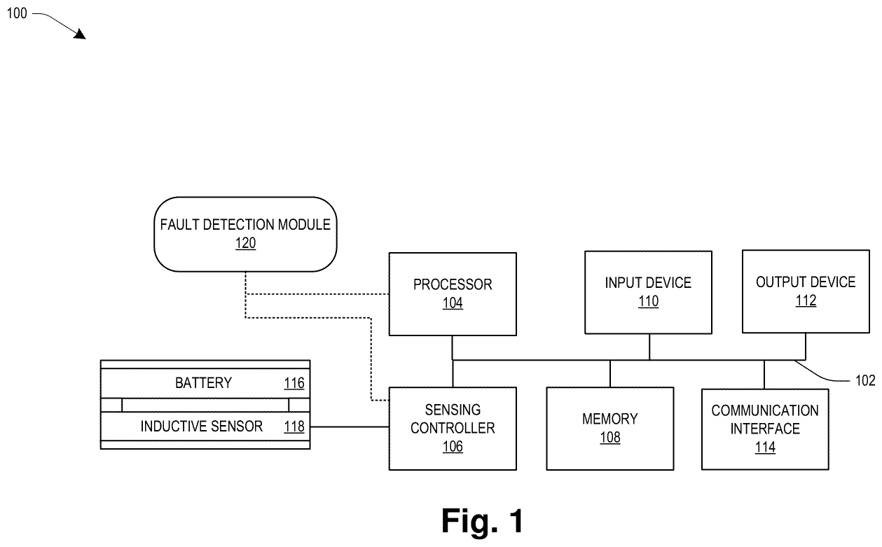

FIG. 1 is a block diagram of a device 100 with battery damage detection, in accordance with some embodiments. In some embodiments, the device 100 comprises a bus 102, a processor 104, a sensing controller 106, a memory 108 that stores software instructions or operations used by the processor 104 or the sensing controller 106, an input device 110, an output device 112, a communication interface 114, a battery 116, and an inductive sensor 118 for detecting battery damage. The sensing controller 106 receives data from the inductive sensor 118 to detect swelling in the battery 116. The processor 104, the sensing controller 106, or both the processor 104 and the sensing controller 106 implement one or more software applications that perform functions of a fault detection module 120. In some embodiments, the sensing controller 106 provides a battery swelling metric to the processor 104, and the processor 104 implements control actions using the fault detection module 120 based on the battery swelling metric. The processor 104 and the sensing controller 106 may be separate processing units or the processor 104 and the sensing controller 106 may be integrated into a single processing unit. The device 100 may include fewer components, additional components, different components, and/or a different arrangement of components than those illustrated in FIG. 1.

According to some embodiments, the bus 102 includes one or more paths that permit communication among the components of the device 100. For example, the bus 102 may include multiple buses, such as system buses, address buses, data buses, or control buses. The bus 102 may also include bus drivers, bus arbiters, bus interfaces, clocks, and so forth. The components illustrated in FIG. 1 may be on different buses. For example, the memory 108 may be on one bus and the communication interface 114 may be on a different bus. The processor 104 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. The processor 104 may be implemented as hardware (e.g., a microprocessor, etc.), a combination of hardware and software (e.g., a programmable system on a chip (PSoC™), an application specific integrated circuit (ASIC), etc.), may include one or multiple memories (e.g., cache, etc.), etc.

In some embodiments, the processor 104 controls the overall operation or a portion of the operation(s) performed by the device 100. The processor 104 performs one or multiple operations based on an operating system and/or various applications or computer programs (e.g., software). The processor 104 accesses instructions from the memory 108, from other components of the device 100, and/or from a source external to the device 100 (e.g., a network, another device, etc.). The processor 104 may perform an operation and/or a process based on various techniques including, for example, multithreading, parallel processing, pipelining, interleaving, etc.

In some embodiments, the sensing controller 106 may be implemented as hardware (e.g., a microprocessor, etc.), a combination of hardware and software (e.g., a PSoC™, an ASIC, etc.). In some embodiments, the sensing controller 106 is a CAPSENSE™ microcontroller.

In some embodiments, the memory 108 includes one or multiple memories and/or one or multiple other types of storage mediums. For example, the memory 108 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other suitable type of memory. The memory 108 may include a hard disk, a magnetic disk, an optical disk, a magneto-optic disk, a solid state disk, a Micro-Electromechanical System (MEMS)-based storage medium, a nanotechnology-based storage medium, and/or some other suitable disk. The memory 108 may include drives for reading from and writing to the storage medium. The memory 108 may be external to and/or removable from the device 100, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). The memory 108 may store data, software, and/or instructions related to the operation of the fault detection module 120.

The communication interface 114 permits the device 100 to communicate with other devices, networks, systems, sensors, and/or the like on a network. The communication interface 114 may include one or multiple wireless interfaces and/or wired interfaces. For example, the communication interface 114 may include one or multiple transmitters and receivers, or transceivers. The communication interface 114 may operate according to a protocol stack and a communication standard. In some embodiments, the communication interface 114 includes an antenna. The communication interface 114 may include various processing logic or circuitry (e.g., multiplexing/de-multiplexing, filtering, amplifying, converting, error correction, etc.). In some embodiments, the communication interface 114 operates using a long range wireless protocol, such as a cellular protocol or a Wi-Fi® protocol, a short range protocol, such as Bluetooth®, or a wired protocol, such as Ethernet.

In some embodiments, the input device 110 permits an input into the device 100. For example, the input device 110 may comprise one or more of a keyboard, a mouse, a display, a touch pad, a touchscreen, a touchless screen, a button, a switch, an input port, speech recognition logic, and/or some other type of suitable visual, auditory, or tactile input component. In some embodiments, the sensing controller 106 performs sensing functions in the device 100 in addition to the determination of the battery swelling metric using the inductive sensor 118. For example, one of the input devices 110 may be a capacitive sensor, such as a touch pad, and the sensing controller 106 may perform capacitive sensing functions to receive user input for the device 100.

The output device 112 permits an output from the device 100. For example, the output device 112 may include a speaker, a display, a touchscreen, a touchless screen, a projected display, a light, an output port, and/or some other type of suitable visual, auditory, or tactile output component.

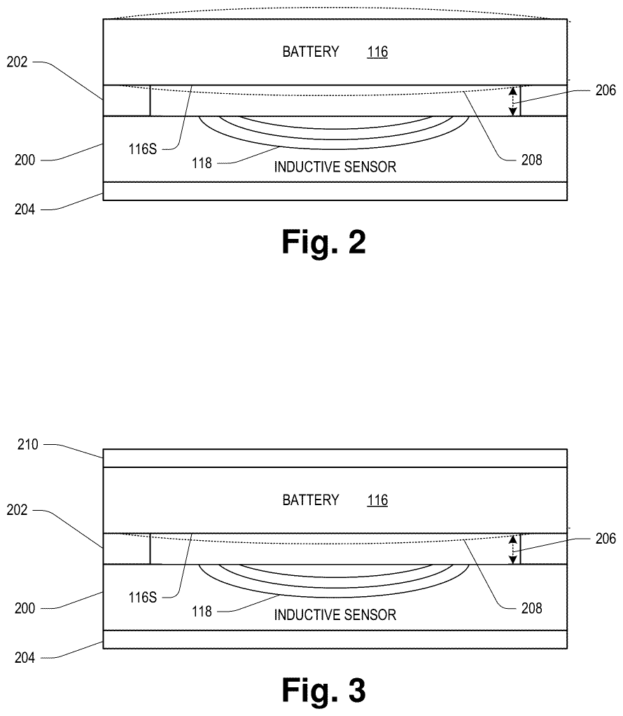

FIGS. 2 and 3 are diagrams of the battery 116 interfacing with the inductive sensor 118, in accordance with some embodiments. In some embodiments, the inductive sensor 128 is provided in a printed circuit board 200 and a spacer 202 is provided between the inductive sensor 128 and the battery 116. The battery 116 comprises a conductive surface 116S, such as a conductive shell or a conductive film. For example, the conductive surface 116S may comprise aluminum as a rigid casing material or a flexible film. In some embodiments, a stiffening layer 204 is provided adjacent the printed circuit board 200 to reduce flexing of the printed circuit board 200 due to movement, expansion, or contraction of the device 100. The spacer 202 separates the printed circuit board 200 from the battery 116 to provide a gap 206 therebetween. Damage to the battery 116 from overcharging, overdischarging, or overcurrent, for example, can cause swelling of the battery 116 represented by the dashed line 208. The inductive sensor 118 detects the swelling by measuring the distance between the printed circuit board 200 and the battery 116. The spacer 202 may be provided as part of the housing of the device 100 to separate various components. In some embodiments, the stiffening layer 204 comprises plastic or some other material that does not interfere with the inductive sensor 128.

Referring to FIG. 3, an additional stiffening layer 210 is provided over the outer surface of the battery 116 to reduce or prevent swelling in the direction opposite the gap 206, thereby increasing the sensitivity of the battery swelling measurement.

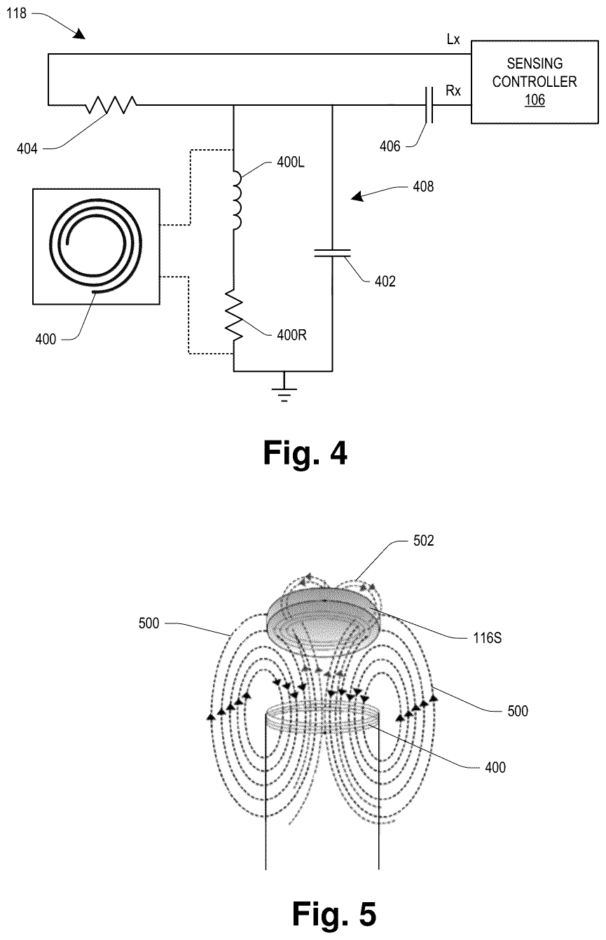

FIG. 4 is a circuit diagram of an example embodiment of the inductive sensor 118, in accordance with some embodiments. In some embodiments, the inductive sensor 118 comprises an inductive coil 400, represented by an inductor 400L with inductance L and a resistor 400R with resistance Rs, a tank capacitor 402 with capacitance C, a transmitter resistor 404, and a coupling capacitor 406. The inductive coil 400 and the tank capacitor 402 form a tank circuit 408. Other structures and/or configurations of the inductive sensor 118 are within the scope of the present disclosure.

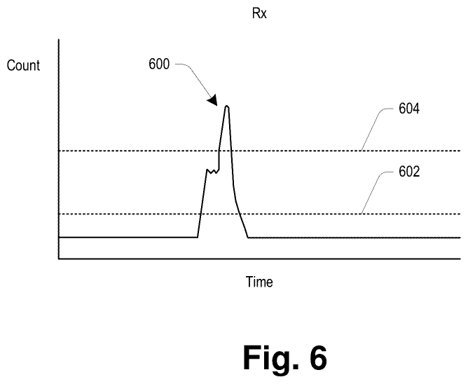

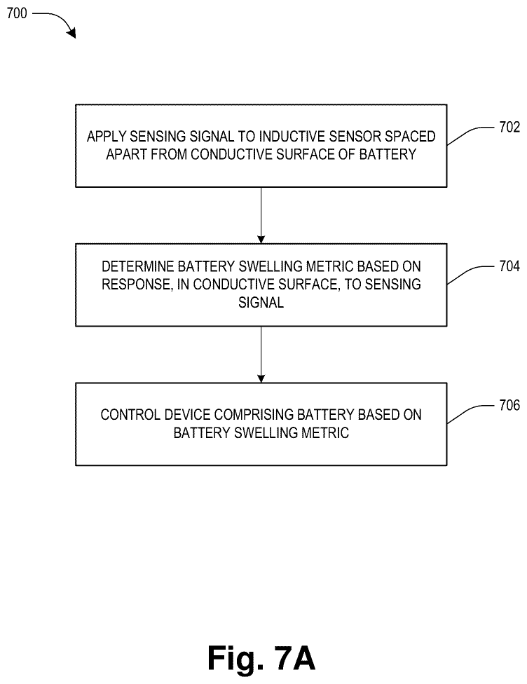

FIGS. 5 and 6 are diagrams illustrating inductive sensing, in accordance with some embodiments. The sensing controller 106 generates an excitation signal (Lx) having a resonant frequency defined by:

$${f}_{0} = \frac{1}{2 π} \sqrt{\frac{1}{LC} - {( \frac{{R}_{S}}{L} )}^{2}} .$$

The excitation signal (Lx) generates a magnetic field 500 in the inductive coil 400. The magnetic field 500 induces an eddy current in the conductive surface 116S of the battery 116 which generates a corresponding magnetic field 502 that is received in the inductive coil 400 and the tank circuit 408. The output signal from the tank circuit 408 is received by the sensing controller 106 through the coupling capacitor 406 as a receive signal (Rx) 600. The receive signal (Rx) represents changes in the amplitude of the voltage at the tank circuit 408 based on the inductance between the inductive coil 400 and the conductive surface 116S of the battery 116. The units of the receive signal (Rx) are a count generated by an analog-to-digital converter (ADC) based on the amplitude of the voltage.

The amplitude of the receive signal (Rx) 600 is affected by the proximity of the conductive surface 116S of the battery 116 to the inductive coil 400. The distance between the inductive coil 400 and the conductive surface 116S of the battery 116 determines the amplitude of the receive signal (Rx) 600, which is inversely affected by the distance. Changes to the amplitude of the receive signal (Rx) 600 are correlated to swelling of the battery 116 to generate a battery swelling metric. The sensing controller 106 may use an equation or lookup table to generate the battery swelling metric depending on the geometry of the device 100.

In some embodiments, the battery swelling metric generated by the sensing controller 106 using the inductive sensor 118 is used to control the device 100, such as by sending an alert message or by modifying an operating parameter of the device 100 to control charging of the device 100, shut down the device 100, or modify some other operating parameter of the device 100.

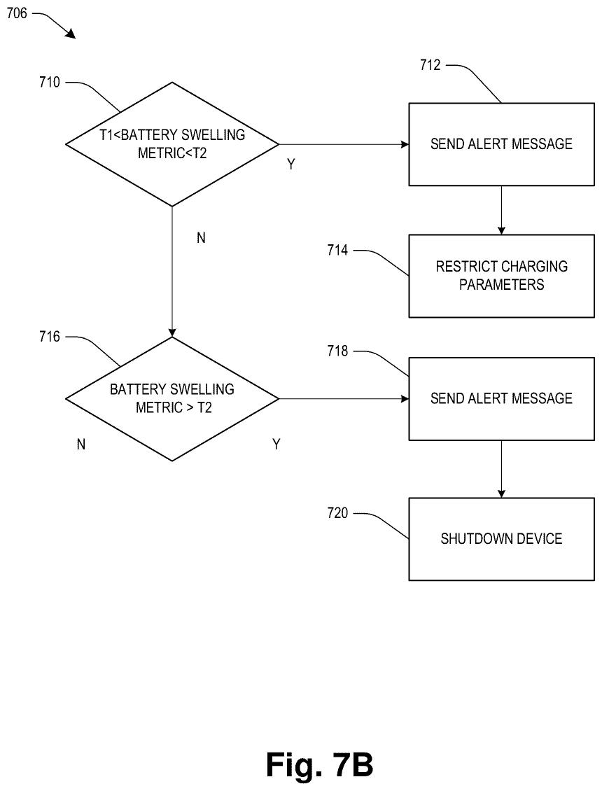

FIGS. 7A and 7B are diagrams illustrating a method 700 for battery fault detection and mitigation, in accordance with some embodiments. At 702, the sensing controller 106 applies an excitation signal 600 to an inductive sensor 118 spaced apart from a conductive surface 118S layer of a battery 116. At 704, the sensing controller 106 determines a battery swelling metric based on a response 602, in the conductive surface 118S, to the excitation signal 600. At 706, a device 100 comprising the battery 116 is controlled, for example by the sensing controller 106 or the processor 104, based on the battery swelling metric.

FIG. 7B illustrates an embodiment for controlling the device 100 at 706 in the method 700, in accordance with some embodiments. Various thresholds 602, 604 may be employed to evaluate the battery swelling metric and trigger different control actions. For example, the threshold 602 (T1) may represent a first level of battery swelling, and the second threshold 604 (T2) may represent a second level of battery swelling greater than the first level. In some embodiments, the processor 104 may implement a more restrictive control action responsive to the battery charging metric exceeding the second threshold 604 corresponding to a greater degree of swelling than the first threshold 602.

At 710, the battery swelling metric is compared to the thresholds 602, 604 (T1, T2). Responsive to the battery swelling metric exceeding the first threshold 602 (T1) but not the second threshold 604 (T2), an alert message is sent at 712. The alert message may include a visual message on a display of the device 100, an audible message, an email message, a text message, or some other type of alert message. Providing the alert message allows the user to take corrective action, such as replacing the battery 116, prior to further damage to the battery 116 or the device 100.

In some embodiments, the charging parameters for the device 100 are restricted at 714. The alert message sent at 712 may indicate that the charging of the device 100 will be restricted. The processor 104 may control the charging of the battery 116, for example, by negotiating a power delivery contract with a power adaptor connected to the device 100 according to a charging protocol, such as a Universal Serial Bus Power Delivery (USB-PD) protocol. The power delivery contract may specify a voltage and a current for charging the battery 116. In some embodiments, the processor 104 limits the charging voltage or the charging current in the power delivery contract based on the battery swelling metric determined by the fault detection module 120 to reduce the likelihood of further battery damage.

Responsive to the battery swelling metric exceeding the second threshold 604 (T2) at 716, an alert message is sent at 718 and, after a predetermined time period or confirmation of the alert message, the device 100 is shut down at 720. The alert message sent at 712 may indicate that further operation of the device 100 is not allowed due to the battery damage. The alert message may include a visual message on a display of the device 100, an audible message, an email message, a text message, or some other type of alert message. Providing the alert message allows the user to take corrective action, such as replacing the battery 116. If the device 100 is subsequently reset, the processor 104 may allow the device 100 to be started for purposes of repeating the battery damage alert message and subsequently shut down the device 100 again. In some embodiments, the user may be provided with an emergency override option to allow use of the device 100 for emergency purposes. In some embodiments, the emergency override option may have a restricted time period for allowed operation.

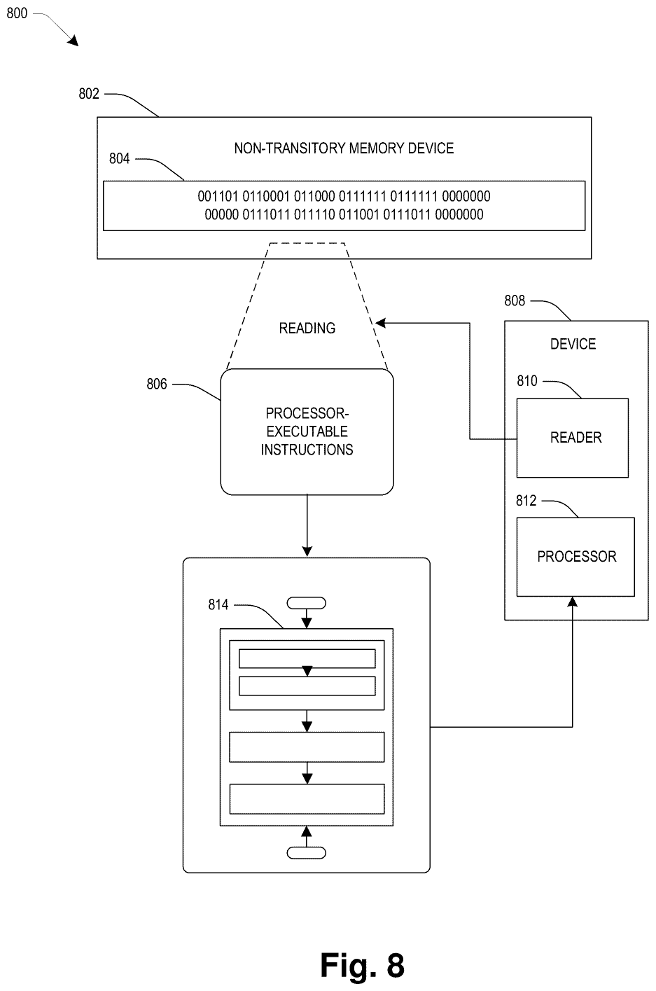

FIG. 8 illustrates an exemplary embodiment 800 of a computer-readable medium 802, in accordance with some embodiments. One or more embodiments involve a computer-readable medium comprising processor-executable instructions configured to implement one or more of the techniques presented herein. The embodiment 800 comprises a non-transitory computer-readable medium 802 (e.g., a CD-R, DVD-R, flash drive, a platter of a hard disk drive, etc.), on which is encoded computer-readable data 804. This computer-readable data 804 in turn comprises a set of processor-executable computer instructions 806 that, when executed by a computing device 808 including a reader 810 for reading the processor-executable computer instructions 806 and a processor 812 for executing the processor-executable computer instructions 806, are configured to facilitate operations according to one or more of the principles set forth herein. In some embodiments, the processor-executable computer instructions 806, when executed, are configured to facilitate performance of a method 814, such as at least some of the aforementioned method(s). In some embodiments, the processor-executable computer instructions 806, when executed, are configured to facilitate implementation of a system, such as at least some of the one or more aforementioned system(s). Many such computer-readable media may be devised by those of ordinary skill in the art that are configured to operate in accordance with the techniques presented herein.

In an embodiment of the techniques presented herein, a device comprises a battery comprising a conductive surface, an inductive sensor, a spacer between the inductive sensor and the conductive surface, and a processing unit connected to the inductive sensor and configured to apply an excitation signal to the inductive sensor, determine a battery swelling metric based on a response, in the conductive surface, to the excitation signal, and control the device based on the battery swelling metric.

In an embodiment of the techniques presented herein, the processing unit is configured to control the device to generate an alert message based on the battery swelling metric.

In an embodiment of the techniques presented herein, the processing unit is configured to control the device to set a charging parameter for the battery based on the battery swelling metric.

In an embodiment of the techniques presented herein, the processing unit is configured to control the device to shut down the device based on the battery swelling metric.

In an embodiment of the techniques presented herein, the device comprises a stiffening layer adjacent the inductive sensor to inhibit movement of the inductive sensor.

In an embodiment of the techniques presented herein, the device, comprises a stiffening layer adjacent the battery to inhibit movement of the battery.

In an embodiment of the techniques presented herein, the inductive sensor comprises an inductive coil, and a tank circuit connected in parallel with the inductive coil.

In an embodiment of the techniques presented herein, the conductive surface comprises one of a conductive shell or a conductive film.

In an embodiment of the techniques presented herein, the processing unit is configured to control the device to generate an alert message responsive to the battery swelling metric exceeding a first threshold; and control the device to modify an operating parameter of the device responsive to the battery swelling metric exceeding a second threshold.

In an embodiment of the techniques presented herein, a method comprises applying an excitation signal to an inductive sensor spaced apart from a conductive surface of a battery, determining a battery swelling metric based on a response, in the conductive surface, to the excitation signal, and controlling a device comprising the battery based on the battery swelling metric.

In an embodiment of the techniques presented herein, controlling the device based on the battery swelling metric comprises generating an alert message.

In an embodiment of the techniques presented herein, controlling the device based on the battery swelling metric comprises setting a charging parameter for the battery.

In an embodiment of the techniques presented herein, controlling the device based on the battery swelling metric comprises shutting down the device.

In an embodiment of the techniques presented herein, applying the excitation signal comprises applying the excitation signal to an inductive coil connected in parallel to a tank circuit.

In an embodiment of the techniques presented herein, a device comprises a battery comprising a conductive surface, an inductive sensor, a spacer between the inductive sensor and the conductive surface, and a processing unit connected to the inductive sensor and configured to apply an excitation signal to the inductive sensor, determine a distance between the inductive sensor and the battery based on a response, in the conductive surface, to the excitation signal, and control the device based on the distance, wherein controlling the device comprises generating an alert message responsive to the distance being less than a first threshold, and changing an operating parameter of the device responsive to the distance being less than a second threshold that is less than the first threshold.

In an embodiment of the techniques presented herein, the operating parameter comprises a charging parameter for the battery.

In an embodiment of the techniques presented herein, the processing unit is configured to shut down the device responsive to the distance being less than a third threshold that is less than the second threshold.

In an embodiment of the techniques presented herein, the device comprises a stiffening layer adjacent the inductive sensor to inhibit movement of the inductive sensor.

In an embodiment of the techniques presented herein, the device comprises a stiffening layer adjacent the battery to inhibit movement of the battery.

In an embodiment of the techniques presented herein, the inductive sensor comprises an inductive coil, and a tank circuit connected in parallel with the inductive coil.

The term “computer readable media” may include communication media. Communication media typically embodies computer readable instructions or other data in a “modulated data signal” such as a carrier wafer or other transport mechanism and includes any information delivery media.

The term “modulated data signal” may include a signal that has one or more of its characteristics set or changed in such a manner as to encode information in the signal.

Any aspect or design described herein as an “example” and/or the like is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A device, comprising:
a battery comprising a conductive surface;
an inductive sensor;
a spacer between the inductive sensor and the conductive surface; and
a processing unit connected to the inductive sensor and configured to:
apply an excitation signal to the inductive sensor;
determine a battery swelling metric based on a response, in the conductive surface, to the excitation signal; and
control the device based on the battery swelling metric.

2. The device of claim 1, wherein:
the processing unit is configured to control the device to generate an alert message based on the battery swelling metric.

3. The device of claim 1, wherein:
the processing unit is configured to control the device to set a charging parameter for the battery based on the battery swelling metric.

4. The device of claim 1, wherein:
the processing unit is configured to control the device to shut down the device based on the battery swelling metric.

5. The device of claim 1, comprising:
a stiffening layer adjacent the inductive sensor to inhibit movement of the inductive sensor.

6. The device of claim 1, comprising:
a stiffening layer adjacent the battery to inhibit movement of the battery.

7. The device of claim 1, wherein the inductive sensor comprises:
an inductive coil; and
a tank circuit connected in parallel with the inductive coil.

8. The device of claim 1, wherein:
the conductive surface comprises one of a conductive shell or a conductive film.

9. The device of claim 1, wherein:
the processing unit is configured to:
control the device to generate an alert message responsive to the battery swelling metric exceeding a first threshold; and
control the device to modify an operating parameter of the device responsive to the battery swelling metric exceeding a second threshold.

10. A method, comprising:
applying an excitation signal to an inductive sensor spaced apart from a conductive surface of a battery;
determining a battery swelling metric based on a response, in the conductive surface, to the excitation signal; and
controlling a device comprising the battery based on the battery swelling metric.

11. The method of claim 10, wherein:
controlling the device based on the battery swelling metric comprises generating an alert message.

12. The method of claim 10, wherein:
controlling the device based on the battery swelling metric comprises setting a charging parameter for the battery.

13. The method of claim 10, wherein:
controlling the device based on the battery swelling metric comprises shutting down the device.

14. The method of claim 10, wherein applying the excitation signal comprises:
applying the excitation signal to an inductive coil connected in parallel to a tank circuit.

15. A device, comprising:
a battery comprising a conductive surface;
an inductive sensor;
a spacer between the inductive sensor and the conductive surface; and
a processing unit connected to the inductive sensor and configured to:
apply an excitation signal to the inductive sensor;
determine a distance between the inductive sensor and the battery based on a response, in the conductive surface, to the excitation signal; and
control the device based on the distance, wherein controlling the device comprises:
generating an alert message responsive to the distance being less than a first threshold; and
changing an operating parameter of the device responsive to the distance being less than a second threshold that is less than the first threshold.

16. The device of claim 15, wherein:
the operating parameter comprises a charging parameter for the battery.

17. The device of claim 15, wherein:
the processing unit is configured to shut down the device responsive to the distance being less than a third threshold that is less than the second threshold.

18. The device of claim 15, comprising:
a stiffening layer adjacent the inductive sensor to inhibit movement of the inductive sensor.

19. The device of claim 15, comprising:
a stiffening layer adjacent the battery to inhibit movement of the battery.

20. The device of claim 15, wherein the inductive sensor comprises:
an inductive coil; and
a tank circuit connected in parallel with the inductive coil.
